(19) United States
(12) Patent Application Publication
(10) Pub. No.: US 2025/0279546 A1
(43) Pub. Date: Sep. 4, 2025

(54) BATTERY INCLUDING SEPARATOR AND ELECTRONIC DEVICE INCLUDING SAME

(71) Applicant: Samsung Electronics Co., Ltd., Suwon-si (KR)

(72) Inventor: Woongchul CHOI, Suwon-si (KR)

(21) Appl. No.: 19/202,754

(22) Filed: May 8, 2025

Related U.S. Application Data
(63) Continuation of application No. PCT/KR2023/015273, filed on Oct. 4, 2023.

(30) Foreign Application Priority Data
Nov. 15, 2022 (KR) 10-2022-0152860
Dec. 15, 2022 (KR) 10-2022-0175719

(51) Int. Cl. H01M 50/491; H01M 50/414; H01M 50/44

(52) U.S. Cl. CPC H01M 50/491; H01M 50/414; H01M 50/44

(57) ABSTRACT

A battery is provided. The battery includes a first electrode, a second electrode spaced apart from the first electrode, and a separator including a fiber disposed between the first electrode and the second electrode, the fiber including a core and a sheath at least partially surrounding the core, wherein the core of the fiber includes a phase change material, and wherein the sheath of the fiber includes a polymer material.

### CROSS-REFERENCE TO RELATED APPLICATION(S)

This application is a continuation application, claiming priority under 35 U.S.C. § 365(c), of an International application No. PCT/KR2023/015273, filed on Oct. 4, 2023, which is based on and claims the benefit of a Korean patent application number 10-2022-0152860, filed on Nov. 15, 2022, in the Korean Intellectual Property Office, and of a Korean patent application number 10-2022-0175719, filed on Dec. 15, 2022, in the Korean Intellectual Property Office, the disclosure of each of which is incorporated by reference herein in its entirety.

### BACKGROUND

### 1. Field

The disclosure relates to a battery including a separator and an electronic device including the same.

### 2. Description of Related Art

An electronic device may include various electronic components. The electronic device may include a battery for providing power to the electronic components. The battery may include a separator disposed between a positive electrode and a negative electrode. The separator may include pores for passing ions (e.g., lithium ions).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a battery including a separator and an electronic device including the same.

Additional aspects will be set forth in part in the description which follows and, in part, will be apparent from the description, or may be learned by practice of the presented embodiments.

In accordance with an aspect of the disclosure, a battery is provided. The battery includes a first electrode, a second electrode spaced apart from the first electrode, and a separator including a fiber disposed between the first electrode and the second electrode, the fiber including a core and a sheath at least partially surrounding the core, wherein the core of the fiber includes a phase change material, and wherein the sheath of the fiber includes a polymer material.

In accordance with another aspect of the disclosure, an electronic device is provided. The electronic device includes a battery configured to provide power to at least one component of the electronic device, and power management integrated circuitry (PMIC) configured to manage the power provided from the battery to the at least one component, wherein the battery includes a first electrode, a second electrode spaced apart from the first electrode, and a separator including a fiber disposed between the first electrode and the second electrode, the fiber including a core and a sheath at least partially surrounding the core, wherein the core of the fiber includes a phase change material, and wherein the sheath of the fiber includes a polymer material.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a block diagram of a power management module and a battery according to an embodiment of the disclosure;

FIG. 2B is a block diagram of an electronic device according to an embodiment of the disclosure;

FIG. 3A schematically illustrates a battery according to an embodiment of the disclosure;

FIG. 3B is an enlarged view of an X region of the battery of FIG. 3A according to an embodiment of the disclosure;

FIG. 3C is a schematic exploded perspective view of a battery according to an embodiment of the disclosure;

FIG. 4A schematically illustrates an electrospinning device for manufacturing a separator according to an embodiment of the disclosure;

FIG. 4B schematically illustrates a separator manufactured by the manufacturing method of FIG. 4A according to an embodiment of the disclosure;

FIG. 5A is a cross-sectional view of a separator cut along line A-A′ of FIG. 4B according to an embodiment of the disclosure;

FIG. 5B is a cross-sectional view of a separator cut along line B-B′ of FIG. 4B according to an embodiment of the disclosure;

FIG. 6A schematically illustrates a state in which a separator absorbs heat energy according to an embodiment of the disclosure;

FIG. 6B schematically illustrates a separator that has absorbed heat energy according to an embodiment of the disclosure; and

FIG. 7 illustrates a state in which an external object penetrates a battery according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi™ chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

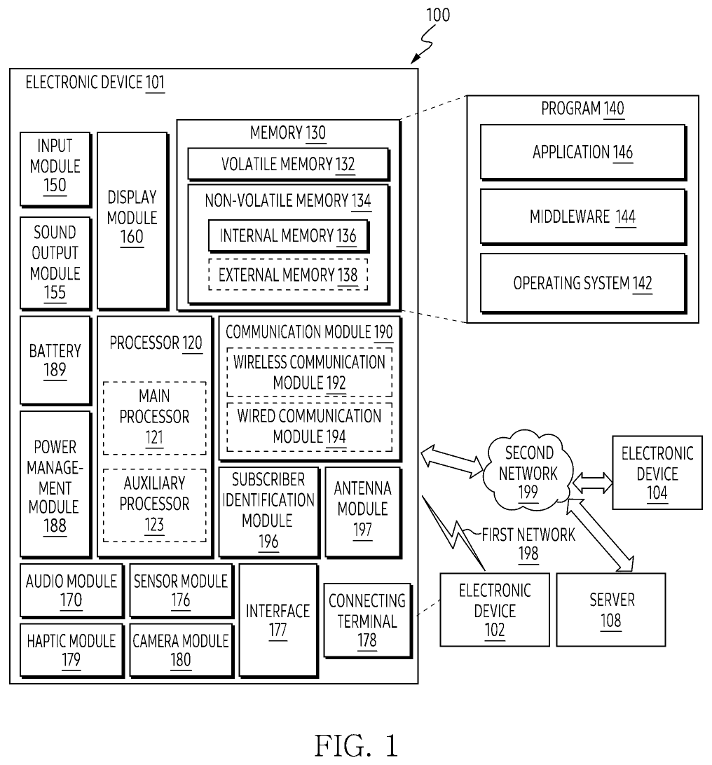

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi™) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., the electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

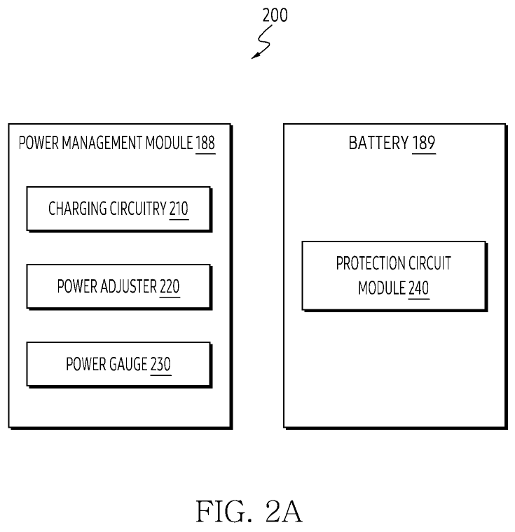

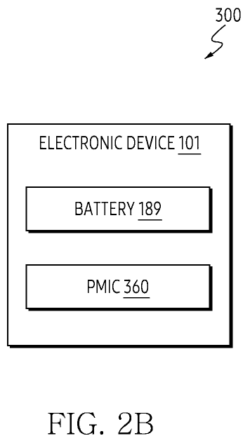

FIG. 2A is a block diagram of a power management module and a battery according to an embodiment of the disclosure.

FIG. 2B is a block diagram of an electronic device according to an embodiment of the disclosure.

FIG. 2A is a block diagram illustrating a power management module and a battery according to an embodiment of the disclosure.

Referring to FIG. 2A, block diagram 200 illustrates that a power management module 188 may include charging circuitry 210, a power adjuster 220, or a power gauge 230. The charging circuitry 210 may charge a battery 189 by using power supplied from an external power source outside the electronic device 101. According to an embodiment, the charging circuitry 210 may select a charging scheme (e.g., normal charging or quick charging) based at least in part on a type of the external power source (e.g., a power outlet, a USB, or wireless charging), magnitude of power suppliable from the external power source (e.g., about 20 Watt or more), or an attribute of the battery 189, and may charge the battery 189 using the selected charging scheme. The external power source may be connected with the electronic device 101, for example, directly via the connecting terminal 178 or wirelessly via the antenna module 197.

The power adjuster 220 may generate a plurality of powers having different voltage levels or different current levels by adjusting a voltage level or a current level of the power supplied from the external power source or the battery 189. The power adjuster 220 may adjust the voltage level or the current level of the power supplied from the external power source or the battery 189 into a different voltage level or current level appropriate for each of some of the components included in the electronic device 101. According to an embodiment, the power adjuster 220 may be implemented in the form of a low drop out (LDO) regulator or a switching regulator. The power gauge 230 may measure use state information about the battery 189 (e.g., a capacity, a number of times of charging or discharging, a voltage, or a temperature of the battery 189).

The power management module 188 may determine, using, for example, the charging circuitry 210, the power adjuster 220, or the power gauge 230, charging state information (e.g., lifetime, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. If the state of the battery 189 is determined to abnormal, the power management module 188 may adjust the charging of the battery 189 (e.g., reduce the charging current or voltage, or stop the charging). According to an embodiment, at least some of the functions of the power management module 188 may be performed by an external control device (e.g., the processor 120).

The battery 189, according to an embodiment, may include a protection circuit module (PCM) 240. The PCM 240 may perform one or more of various functions (e.g., a pre-cutoff function) to prevent a performance deterioration of, or a damage to, the battery 189. The PCM 240, additionally or alternatively, may be configured as at least part of a battery management system (BMS) capable of performing various functions including cell balancing, measurement of battery capacity, count of a number of charging or discharging, measurement of temperature, or measurement of voltage.

According to an embodiment, at least part of the charging state information or use state information regarding the battery 189 may be measured using a corresponding sensor (e.g., a temperature sensor) of the sensor module 176, the power gauge 230, or the power management module 188. According to an embodiment, the corresponding sensor (e.g., a temperature sensor) of the sensor module 176 may be included as part of the PCM 240, or may be disposed near the battery 189 as a separate device.

Referring to FIG. 2B, block diagram 300 illustrates that an electronic device 101 may include a battery 189 and power management integrated circuitry (PMIC) 360 (e.g., the power management module 188 of FIG. 2A). According to an embodiment, the electronic device 101 may include components (e.g., a camera, a printed circuit board) for various functions. According to an embodiment, the battery 189 used in the electronic device 101 may be configured to provide power to components of the electronic device 101. The electronic device 101 may include the PMIC 360 to manage power provided from the battery 189 to the components. The PMIC 360 may be configured to convert power provided from the battery 189 into power required by each of the components and distribute the converted power to each of the components.

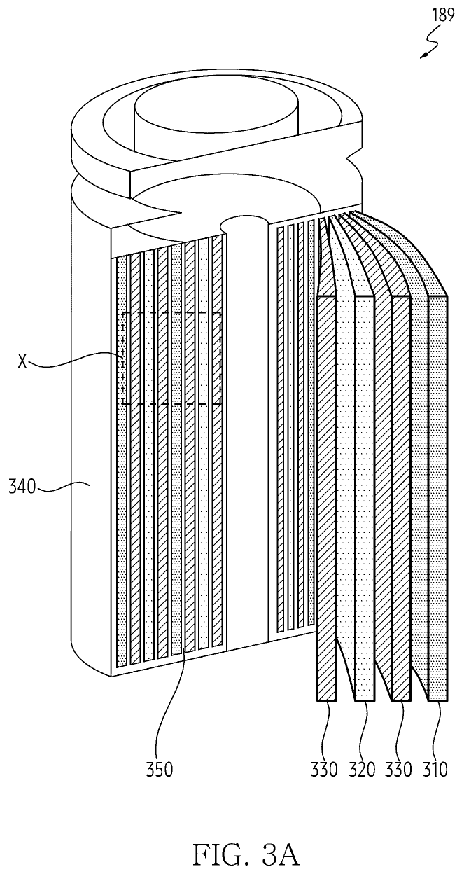

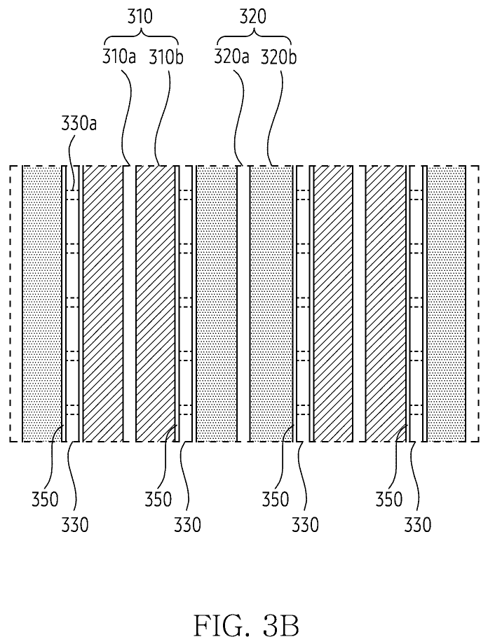

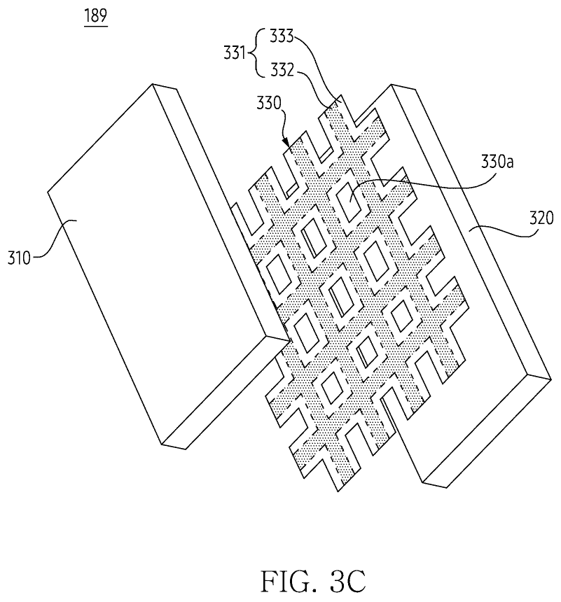

FIG. 3A schematically illustrates a battery according to an embodiment of the disclosure.

FIG. 3B is an enlarged view of an X region of the battery of FIG. 3A according to an embodiment of the disclosure. FIG. 3C is a schematic exploded perspective view of a battery according to an embodiment of the disclosure.

Referring to FIGS. 3A and 3B, a battery 189 according to an embodiment may include a first electrode 310, a second electrode 320, and a separator 330. The battery 189 may include an electrolyte 350 that enables movement of ions (e.g., lithium cations) between the first electrode 310 and the second electrode 320, and/or a case 340 that forms an exterior of the battery 189. The first electrode 310, the second electrode 320, and the separator 330 may be accommodated within the case 340. The electrolyte 350 may enable movement of ions for an electrochemical reaction of the first electrode 310 and the second electrode 320. For example, the separator 330 may include pores (e.g., pores 330a of FIG. 3B) through which ions can pass. The case 340 may accommodate the first electrode 310, the second electrode 320, the separator 330, and the electrolyte 350. According to a shape of the case 340, a type of the battery 189 may be distinguished. For example, as illustrated in FIG. 3A, the battery 189 may be a roll-type battery in which components of the battery 189 are rolled within a cylindrical case, but is not limited thereto. For example, the battery 189 may include a square, cylindrical, or pouch-shaped case 340. The battery 189 may be a stack-type battery 189 in which components within the case 340 are alternately laminated.

According to an embodiment, the first electrode 310 and the second electrode 320 may be electrically different. For example, the first electrode 310 may be referred to as a positive electrode in which cations (e.g., lithium ions), during discharge, receive electrons and are reduced. The first electrode 310 may include a positive electrode substrate 310a coated with a positive electrode active material 310b. For example, the second electrode 320 may be referred to as a negative electrode in which cations (e.g., lithium ions), during discharge, release electrons and are oxidized. The second electrode 320 may include a negative electrode substrate 320a coated with a negative electrode active material 320b. According to an embodiment, the first electrode 310 and the second electrode 320 may be spaced apart from each other. For example, the second electrode 320 may be spaced apart from the first electrode 310.

According to an embodiment, the separator 330 may be disposed between the first electrode 310 and the second electrode 320 so that the first electrode 310 and the second electrode 320 do not contact each other. The separator 330 may be configured to prevent a short circuit due to contact between the first electrode 310 and the second electrode 320, by physically separating the first electrode 310 and the second electrode 320. For example, when the first electrode 310 and the second electrode 320 are in direct physical contact, a short circuit current may flow along the first electrode 310 and the second electrode 320. Since the short circuit current may generate local heat inside the battery 189, a temperature of the battery 189 may rapidly increase, which may cause a fire in the battery 189.

According to an embodiment, the separator 330 may be configured to pass ions of the electrolyte 350. For example, the separator 330 may be a porous separator 330 including fine pores 330a for passing ions. For example, the separator 330 may include fine pores 330a formed between fibers 331. For example, lithium ions in the electrolyte 350 may be movable between the first electrode 310 and the second electrode 320 through the pores 330a of the separator 330.

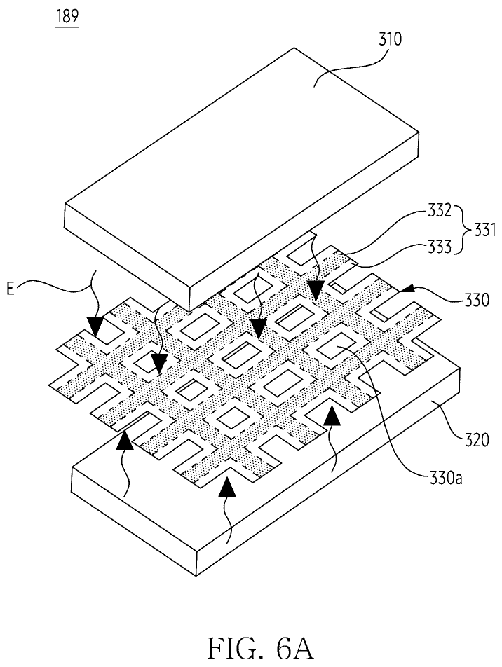

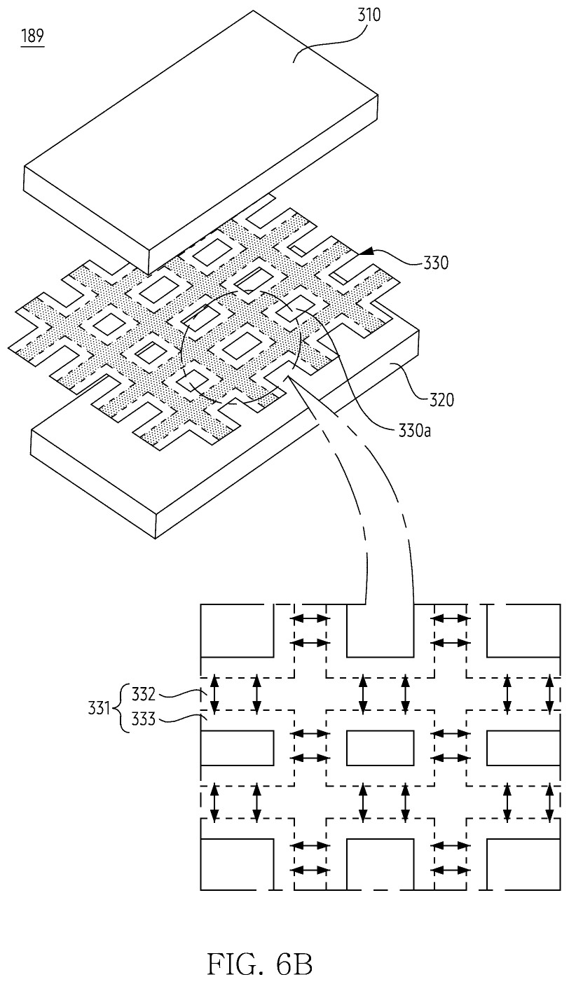

Referring to FIGS. 3B and 3C, a separator 330 may include a fiber having a core-sheath structure (e.g., fiber 331 of FIG. 3C). According to an embodiment, the separator 330 may be composed of a fiber 331 having a core-sheath structure, which is manufactured by electrospinning method. The separator 330 may be composed of a web formed by the fiber 331 having the core-sheath structure. The electrospinning may apply a high voltage to a solution having viscosity and reduce surface tension of the solution by utilizing a repulsive force of the solution formed by the high voltage. The solution with reduced surface tension may be discharged in a jet form to form the fiber 331. In the separator 330 manufactured by the electrospinning, a core 332 may be disposed in the center. The separator 330 may include the fiber 331 including a sheath 333 that at least partially surrounds the core 332. A method for manufacturing the separator 330 by the electrospinning according to an embodiment will be exemplified with reference to FIGS. 6A and 6B.

According to an embodiment, the separator 330 may be a porous separator. For example, the fiber 331 having a core-sheath structure may be formed by electrospinning. The fiber 331 of the core-sheath structure may be arranged in a grid pattern to form the separator 330. The fiber 331 forming the separator 330 may include a phase change material in the core 332. The fiber 331 forming the separator 330 may include a polymer material within the sheath 333. A space between fibers 331 forming the separator 330 may be pores 330a through which the electrolyte 350 passes. A porosity of the separator 330 may be about 30% to 80%, but is not limited thereto. For example, the porosity of the separator 330 may indicate a volume ratio of the pores 330a with respect to a total volume of the separator 330.

According to an embodiment, the core 332 may include a phase change material. The phase change material may be a material capable of controlling the temperature of the battery 189 by storing a large amount of heat energy or releasing the stored heat energy via a phase change process. For example, when the temperature inside the battery 189 is changed from a temperature lower than a melting point of the phase change material to a temperature higher than the melting point, the phase change material may be changed from solid phase to liquid phase. When the phase change material is changed from solid phase to liquid phase, the phase change material may absorb heat energy. According to an embodiment, the phase change material included in the core 332 may include at least one of paraffin, polyethylene glycol, sodium acetate trihydrate, sodium hydroxide monohydrate, magnesium nitrate hexahydrate, myristic acid, stearic acid, and xylitol. However, the phase change materials described above are not limited thereto. For example, the phase change material may include an inorganic hydrate (e.g., Na₂HPO₄·12H₂O, Na₂SO₄·10H₂O, or Zn(NO₃)·6H₂O), an inorganic salt, and/or a salt hydrate.

According to an embodiment, the sheath 333 may include a polymer material. According to an embodiment, the polymer material may include at least one of polyvinylidene fluoride (PVDF), polydimethylsiloxane (PDMS), polyethylene (PE), polyvinyl alcohol (PVA), and polyvinyl pyrrolidone (PVP). However, the polymer materials described above are merely examples, and are not limited thereto.

According to an embodiment, since the sheath 333 is disposed to at least partially surround the core 332, the sheath 333 may form at least a portion of an outer surface of the fiber 331. In order to prevent foreign substances inside the battery 189 from passing through the separator 330, the separator 330 may be composed of a material having high mechanical strength. Since the sheath 333 forming the outer surface of the fiber 331 includes a polymer material, the mechanical strength of the separator 330 may be determined by the polymer material. The polymer material may include a metallic oxide to provide high mechanical strength to the separator 330. For example, the polymer material may include Al₂O₃, AlOOH, or Mg(OH)₂.

According to an embodiment, the separator 330 including the fiber 331 having the core-sheath structure may reduce a temperature increase of the battery 189. According to an embodiment, a phase change material in the core 332 may be changed from solid phase to liquid phase by absorbing ambient heat energy when a temperature of the battery 189 increases due to a short circuit. When the phase change material undergoes the phase change, the phase change material may absorb heat energy corresponding to melting enthalpy. The heat energy absorption due to the phase change of the phase change material may reduce the temperature increase of the battery 189. The separator 330 may have a relatively thin thickness by forming a separation membrane through the core-sheath structure, without a separate coating layer. For example, the sheath 333 forming the outer surface of the separator 330 may be in contact with the electrolyte 350 within the case 340.

According to an embodiment, the separator 330 including the fiber 331 having the core-sheath structure may be configured to compensate for a contraction of the separator 330 due to a temperature increase. When a temperature of the battery 189 increases, the separator 330 may contract as a size of the pores 330a decreases. When the separator 330 contracts, an internal short circuit may occur due to contact between the first electrode 310 and the second electrode 320. According to an embodiment, when the temperature increases, the core-sheath of the separator 330 may expand. The expansion may reduce the amount of contraction of the contracted portion of the separator 330 by compensating for the contraction of the separator 330. According to an embodiment, the separator 330 may prevent an internal short circuit due to the contraction.

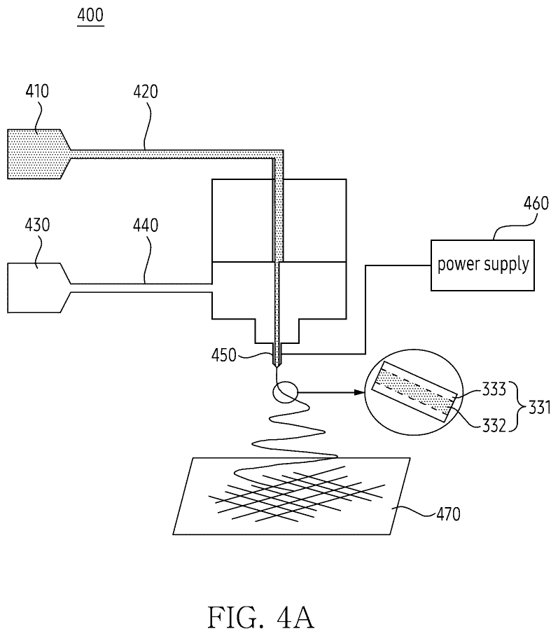

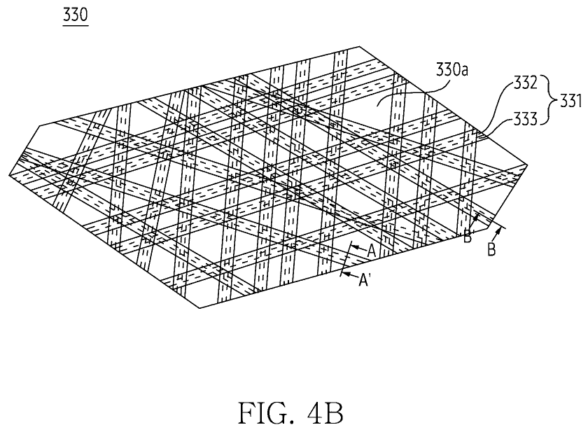

FIG. 4A schematically illustrates an electrospinning device for manufacturing a separator according to an embodiment of the disclosure.

FIG. 4B schematically illustrates a separator manufactured by the manufacturing method of FIG. 4A according to an embodiment of the disclosure.

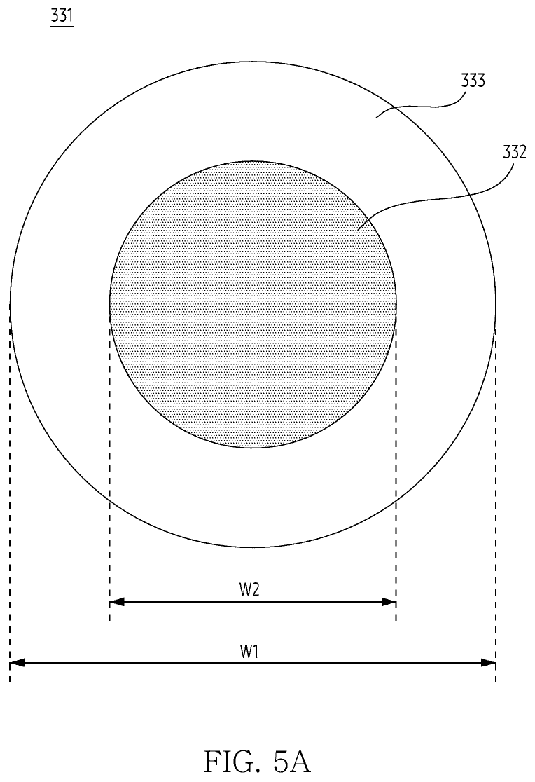

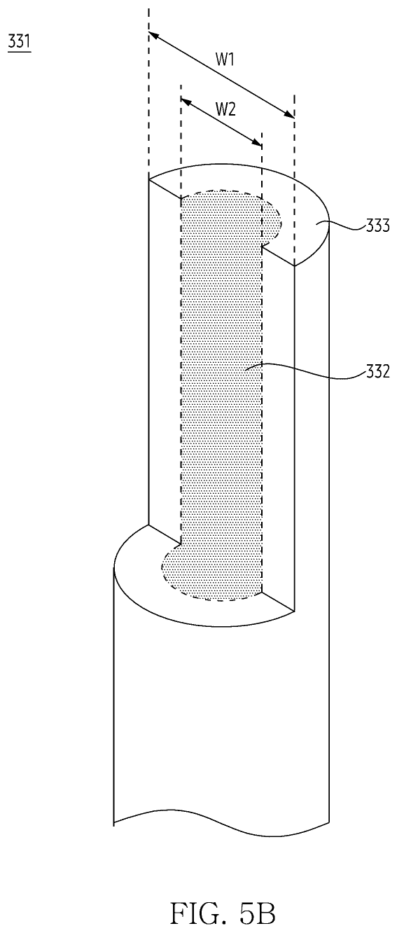

FIG. 5A is a cross-sectional view of a separator cut along line A-A′ of FIG. 4B according to an embodiment of the disclosure.

FIG. 5B is a cross-sectional view of a separator cut along line B-B′ of FIG. 4B according to an embodiment of the disclosure.

Referring to FIG. 4A, a separator (e.g., the separator 330 of FIG. 3C) may be manufactured by electrospinning. The electrospinning is a method of manufacturing a continuous fiber 331 having a width in a range of micrometers to nanometers by using an electric field. When manufacturing the separator 330 by electrospinning, the separator 330 may have a high porosity. The separator 330 may have a large surface area. A structure and a size of the separator 330 may be easily controlled.

According to an embodiment, the separator 330 may be manufactured by an electrospinning device 400. For example, the electrospinning device 400 may include a first container 410 that provides a first solution in which a phase change material is dissolved in a solvent, and a second container 430 that provides a second solution in which a polymer material is dissolved in a solvent. The electrospinning device 400 may include a nozzle tip 450, which is connected to a first duct 420 extending from the first container 410 and a second duct 440 extending from the second container 430. The first solution and a second solution may be discharged through the nozzle tip 450. When being discharged through the nozzle tip 450, the first solution and the second solution may be discharged independently without being mixed.

According to an embodiment, flow rates of the first solution and the second solution may be controlled through a first pump connected to the first container 410 and a second pump connected to the second container 430. A power supply 460 may apply a high voltage (e.g., about 30 kV) to the nozzle tip 450. The first solution and the second solution may be charged by the power supply 460 while passing through the nozzle tip 450. The solutions may form a jet at the nozzle tip 450 due to electrostatic repulsion between charges applied to the solutions and Coulomb force applied to an external electric field. The jet may be elongated into a conical shape (Taylor cone shape). As a solvent volatilizes while a jet of a molten material including a polymer material and a phase change material reaches a current collector (or current collecting screen) 470 disposed below the nozzle tip 450, a fiber 331 having a core-sheath structure may be obtained on the current collector 470. The phase change material and the polymer material may have properties that do not mix with each other to form the core-sheath structure.

Referring to FIG. 4B, a separator 330 manufactured by electrospinning may be porous. Ions (e.g., lithium ions) in an electrolyte (e.g., the electrolyte 350 of FIG. 3A) may pass through the separator 330 through pores 330a between fibers 331 forming the separator 330. However, it is not limited thereto. For example, the fibers 331 may be arranged in a grid pattern. For example, the pores 330a may be formed between the fibers 331. According to an embodiment, a porosity of the separator 330 may be about 30% to 80%, but is not limited thereto. When the separator 330 is manufactured by electrospinning, a separator 330 including a fiber 331 having a core-sheath structure may be manufactured. The fiber 331 forming the separator 330 may include a phase change material within a core 332. The fiber 331 forming the separator 330 may include a polymer material within a sheath 333.

Referring to FIGS. 5A and 5B, a separator (e.g., the separator 330 of FIG. 3C) may include a fiber 331 having a core-sheath. According to an embodiment, the separator 330 may be manufactured by electrospinning, but is not limited thereto. The core 332 may include a phase change material. The sheath 333 surrounding at least a portion of the core 332 may include a polymer material. When a temperature of a battery 189 increases, the phase change material in the core 332 may be changed from solid phase to liquid phase by absorbing heat energy of a system. Since the phase change material absorbs the heat energy of the system when changing phase, the temperature increase of the battery 189 may be reduced. The sheath 333 including a polymer material may reduce the outflow of phase change material that has changed into liquid phase from the core 332 by surrounding at least a portion of the core 332.

According to an embodiment, a width w2 of the core 332 may be about 50% or more of a width w1 of the fiber 331. For example, the width w1 of the fiber 331 may be about 1 nanometer (nm) to about 1,000 nm. The width w2 of the core 332 may be about 0.5 nm to about 500 nm or more. A width of the sheath 333, excluding the width w2 of the core 332 from the width w1 of the fiber 331, may be about 0.5 nm to about 500 nm, but is not limited thereto. For example, the width w1 of the fiber 331 may be referred to as a nano fiber of about 100 nm or less, but is not limited thereto. The width w1 of the fiber 331 may be changed based on design of the battery 189. According to an embodiment, the core 332 may include 10 weight percent (wt %) to 90 wt % of the phase change material based on the weight of the core 332, but is not limited thereto. The phase change material may be 10 wt % to 90 wt % of the core 332.

According to an embodiment, since the separator 330 includes a phase change material inside the fiber 331, it may have a relatively thin thickness. For example, when a phase change material for controlling a temperature of the battery 189 is coated on a surface of the fiber 331, a width of the fiber 331 constituting the separator 330 may increase by a thickness of the coating layer including the phase change material. According to an embodiment, the separator 330 may not include a separate coating layer including the phase change material because it has a core-sheath structure including the phase change material in the core 332 rather than a structure for coating the phase change material on the surface of the fiber 331. When a thickness of the separator 330 is thick, the amount of a positive electrode active material and/or a negative electrode active material included in the battery 189 may decrease, so energy density of the battery 189 may decrease. According to an embodiment, the separator 330 may be a relatively thin because it does not include the coating layer including the phase change material. As the thickness of the separator 330 becomes thinner, the amount of the positive electrode active material and/or the negative electrode active material included in the battery 189 may increase, so the battery 189 according to an embodiment may have a relatively high energy density.

According to an embodiment, for mechanical strength of the separator 330, the sheath 333 may include a polymer material. The polymer material may provide the mechanical strength to the separator 330. The polymer material may protect the core 332 surrounded by the sheath 333. According to an embodiment, the separator 330 may provide stability to the battery 189, while controlling a temperature of the battery 189 without reducing the energy density of the battery 189 by having a thin thickness.

FIG. 6A schematically illustrates a state in which a separator absorbs heat energy according to an embodiment of the disclosure.

FIG. 6B schematically illustrates a separator that has absorbed heat energy according to an embodiment of the disclosure.

Referring to FIG. 6A, a separator 330 may be disposed between a first electrode 310 and a second electrode 320. The separator 330 may prevent occurrence of a short circuit due to contact between the first electrode 310 and the second electrode 320 by separating the first electrode 310 and the second electrode 320 from each other.

According to an embodiment, the separator 330 may be configured to reduce a temperature increase of a battery 189. The temperature of the battery 189 may abnormally increase due to various causes. For example, a short circuit caused by contact between the first electrode 310 and the second electrode 320, overcharge of the battery 189, an impact from the outside of the battery 189, and/or a malfunction of a battery protection circuit (e.g., the protection circuit module 240 of FIG. 2A) may cause overheating of the battery 189. When the battery 189 is continuously overheated, the battery 189 may catches fire.

According to an embodiment, the separator 330 may include a fiber 331 including a core-sheath. A core 332 may include a phase change material. A sheath 333 may include a polymer material. The phase change material included in the core 332 may be changed from solid phase to liquid phase by absorbing heat energy E. For example, a melting point of the phase change material may be about 28° C. to about 90° C., but is not limited thereto. For example, the phase change material may be in solid phase in a temperature below the melting point. When a temperature of a system increase above a melting point temperature of the phase change material, the phase change material may be changed from solid phase to liquid phase by absorbing heat energy E of the system. When the phase change material melts from solid phase to liquid phase, the phase change material may absorb heat energy E corresponding to melting enthalpy.

According to an embodiment, as the temperature of the battery 189 increases, the phase change material may undergo a phase changing. For example, when a short circuit occurs due to contact between the first electrode 310 and the second electrode 320, a short circuit current may flow inside the battery 189. When heat is generated by the short circuit current, the temperature of the battery 189 may increase. When the temperature of the battery 189 increases, a phase change material in the core 332 may be changed from solid phase to liquid phase by absorbing heat energy E inside the battery 189. The heat energy E, which is absorbed when the phase change material undergoes the phase change, may be stored as latent heat in the phase change material. Since the heat energy E may be stored as the latent heat in the phase change material, a temperature increase of the battery 189 may be reduced. Even in a case that a short circuit occurs, the battery 189 according to an embodiment may reduce the temperature increase by the phase change material included in the core 332 of the separator 330. The fire of the battery 189 may be reduced by controlling a rapid temperature increase of the battery 189 through the phase change material.

For example, an electronic device (e.g., the electronic device 101 of FIG. 2B) including the battery 189 may be subjected to an external impact. For example, the electronic device 101 may be dropped from a high position to a low position, or may collide with a physical external object O. When the electronic device 101 is subjected to an external impact, the impact may be transmitted to the battery 189 included inside the electronic device 101. The impact applied to the battery 189 may cause a short circuit inside the battery 189. The short circuit inside the battery 189 may cause a temperature increase of the battery 189, thereby causing the battery 189 to catch fire. When the battery 189 catches fire, other components within the electronic device 101 may be damaged, which may cause unexpected harm to the user. According to an embodiment, when the temperature of the battery 189 increases, a phase change material within the separator 330 may absorb heat energy E and undergo a phase changing, thereby lowering the temperature of the battery 189. As the temperature increase of the battery 189 is suppressed, the occurrence of the battery 189 catching fire may be reduced.

According to an embodiment, in addition to the short circuit of the battery 189, the temperature increase of the battery 189 due to various causes may be reduced. For example, while charging the battery 189, the temperature of the battery 189 may increase. As the temperature of the battery 189 increases, the electrical conductivity decreases, which may deteriorate the charging performance. According to an embodiment, the phase change material in the separator 330 may reduce the temperature increase of the battery 189 by absorbing heat energy E. Since the temperature increase of the battery 189 may be suppressed during a charging process, the charging efficiency of the battery 189 may be improved.

According to an embodiment, the phase change material may include a material that is capable of repeatedly performing melting and solidification processes and having a high latent heat. For example, paraffin may be suitable as a phase change material because it has a relatively high latent heat, enables easy control of a phase change temperature depending on the molecular weight, and is inexpensive.

Referring to FIG. 6B, when the phase change material in a separator 330 absorbs thermal energy E of a battery 189, the separator 330 may expand. For example, when the temperature of the battery 189 increases, a size of pores 330a in the separator 330 may decrease. The separator 330 may have a shutdown function in which the pores 330a are closed to reduce the thermal runaway phenomenon when the battery 189 is overheated. As the pores 330a may be dissolved by the heat, the movement of ions may decrease. As the pores 330a are closed, the movement of ions in the electrolyte 350 may decrease, but the first electrode 310 and the second electrode 320 may be in contact with each other due to a contraction of the separator 330. When the first electrode 310 and the second electrode 320 are in contact with each other, an internal short circuit may occur, causing the temperature of the battery 189 to rapidly increase.

According to an embodiment, as the temperature of the battery 189 increases, the phase change material within the core 332 may be changed from solid phase to liquid phase. As the phase change material is changed to liquid phase, a volume of the phase change material may increase. For example, as the phase change material within the core 332 is changed to liquid phase, a volume of the core 332 may increase by about 10%, but is not limited thereto.

According to an embodiment, when the phase change material included in the core 332 is changed from solid phase to liquid phase, the phase change material in the liquid phase may be surrounded by the sheath 333. According to an embodiment, a melting point of a polymer material may be higher than a melting point of the phase change material. Even when the phase change material undergoes the phase change, the polymer material does not melt, so the sheath 333 may surround at least a portion of the core 332. The sheath 333 may elongate based on the phase change of the phase change material. Since the sheath 333 surrounds at least a portion of the core 332, the sheath 333 may expand by an increase in a volume of the core 332. The sheath 333 may elongate while maintaining a core-sheath structure. As the volume of the core 332 increases, the fibers 331 forming the separator 330 may expand as the sheath 333 surrounding the core 332 elongates. As the fibers 331 forming the separator 330 expand, the separator 330 may expand. As the separator 330 expands, the separator 330 may compensate for the contraction of the separator 330 due to the temperature increase. The polymer material included in the sheath 333 may include a material capable of providing mechanical strength so that the sheath 333 is not damaged when elongated. For example, the polymer material may include metallic oxide, but is not limited thereto.

For example, when an internal short circuit occurs due to the contact between the first electrode 310 and the second electrode 320, the temperature of the battery 189 may increase. The phase change material in the core 332 of the separator 330 may be changed from solid phase to liquid phase by absorbing heat energy E. As the phase change material undergoes the phase change, a volume of the core 332 may increase and the sheath 333 surrounding the core 332 may elongate, thereby increasing a width of the fiber 331. As the width of the fiber 331 increases, the separator 330 may expand. The expansion of the separator 330 may compensate for a contraction of the separator 330 due to an increase in temperature to reduce the contraction of the separator 330. According to an embodiment, as the contraction of the separator 330 is compensated, the separator 330 may physically separate the first electrode 310 and the second electrode 320 and prevent the internal short circuit. The battery 189 according to an example may suppress a temperature increase of the battery 189 and prevent a short circuit by compensating for the contraction of the separator 330. The battery 189 according to an example may provide thermal stability.

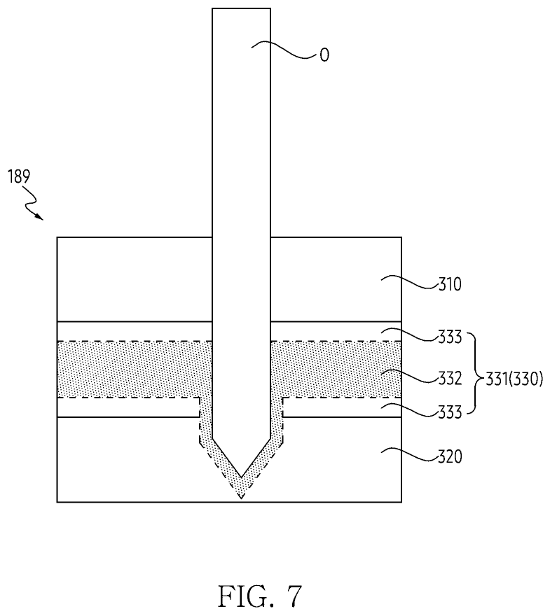

FIG. 7 illustrates a state in which an external object penetrates a battery according to an embodiment of the disclosure.

Referring to FIG. 7, a battery 189 may be damaged by an external object O. For example, the external object O (e.g., a nail or a screw), which is rigid and conductive, may penetrate the battery 189. The external object O may electrically connect a first electrode 310 and a second electrode 320 by penetrating from the first electrode 310 to the second electrode 320. For example, when the external object O includes a conductive material (e.g., metal), the first electrode 310 and the second electrode 320 may be electrically connected through the external object O penetrating the battery 189. When the first electrode 310 and the second electrode 320 are electrically connected, a short circuit may be formed in the battery 189. When the short circuit is formed, a short circuit current may flow along the first electrode 310, the external object O, and the second electrode 320. The short circuit current may generate heat. Due to the generated heat, a temperature of a damaged portion of the battery 189 may increase rapidly, which may cause the battery 189 to catch fire.

According to an embodiment, when the external object O penetrates the battery 189, the external object O may penetrate a separator 330. The short circuit of the battery 189 may occur due to the external object O, and the short circuit may cause a temperature increase of the battery 189. As the temperature of the battery 189 increases, a phase change material in a core 332 may be changed from solid phase to liquid phase by absorbing heat energy. Since the phase change material absorbs heat energy, the temperature increase of the battery 189 due to the short circuit may be reduced.

According to an embodiment, when the external object O penetrates the battery 189, the phase change material in the core 332 may surround the external object O penetrating the separator 330. Referring to FIG. 7, the external object O (e.g., a nail) may be inserted from the first electrode 310 to the second electrode 320 by penetrating the separator 330. When the external object O penetrates the separator 330, a core-sheath structure at a penetration point may be damaged. Since a sheath 333 at the penetration point is damaged, the phase change material in the core 332 may move to the outside of the separator 330. The phase change material may move around the external object O inserted into the second electrode 320 at the penetration point, thereby surrounding the external object O. In a state of surrounding the external object O, the phase change material may be changed from solid phase to liquid phase by absorbing heat energy. Since the phase change material may absorb heat energy in a state of surrounding the external object O, formation of a short-circuit current may be suppressed. For example, the short circuit current may be formed from the first electrode 310 to the second electrode 320 along the external object O. As the phase change material surrounds the external object O at the penetration point, a flow of the short-circuit current flowing from the first electrode 310 to the second electrode 320 through the external object O may be suppressed. According to an embodiment, even when the external object O penetrates the battery 189, the phase change material in the separator 330 may suppress a temperature increase of the battery 189 and a flow of the short-circuit current. According to an embodiment, since the battery 189 catching fire may be suppressed, stability of the battery 189 may be secured.

A battery (e.g., the battery 189 of FIG. 3C) according to an embodiment may include a first electrode (e.g., the first electrode 310 of FIG. 3C), a second electrode (e.g., the second electrode 320 of FIG. 3C), and a separator (e.g., the separator 330 of FIG. 3C). The second electrode may be spaced apart from the first electrode. The separator may be disposed between the first electrode and the second electrode. The separator may include a fiber (e.g., the fiber 331 of FIG. 4B). The fiber may include a core (e.g., the core 332 of FIG. 5A) and a sheath (e.g., the sheath 333 of FIG. 5A). The sheath may at least partially surround the core. The core may include a phase change material. The sheath may include a polymer material. According to an embodiment of the disclosure, the separator may be configured to reduce a temperature increase of the battery. For example, when the temperature of the battery increases due to an internal short circuit, the phase change material in the core may be changed from solid phase to liquid phase by absorbing heat energy. As the temperature increase of the battery is reduced by the phase change material, overheating and/or a fire in the battery may be reduced. The battery according to an embodiment may provide stability during use and efficiently supply power because it does not overheat easily. According to an embodiment, since the separator does not include a separate coating layer and may include a phase change material through a core-sheath structure, the separator may be relatively thin. Since the separator is thin, the battery may have a relatively high energy density.

According to an embodiment, the phase change material may be configured to reduce, when the temperature of the battery increases, the temperature increase of the battery by a phase changing from solid phase to liquid phase. According to an embodiment of the disclosure, when the phase change material is changed to liquid phase, the phase change material may absorb heat energy corresponding to melting enthalpy. Since the temperature increase of the battery may be reduced by the phase change material, stability may be ensured when the battery is used.

According to an embodiment, as the phase change material in the core is changed from solid phase to liquid phase when the temperature of the battery increases, the separator may expand. The separator may compensate for a contraction of the separator through the expansion of the separator. According to an embodiment of the disclosure, when the temperature of the battery increases, pores in the separator may be closed. As the pores are closed, the separator may contract. The contraction of the separator may cause a short circuit in the battery. According to an embodiment, a volume of a phase change material in the core may increase when changing from solid phase to liquid phase. Through an increase in the volume of the phase change material, the fiber including the core and the sheath may expand. Since the fiber forming the separator expands, the separator may expand. The expansion of the separator may compensate for the contraction of the separator due to the temperature increase of the battery. According to an embodiment, since the separator may compensate for the contraction of a portion that contracts when the temperature of the battery increases, a short circuit due to contact between a positive electrode and a negative electrode may be prevented.

According to an embodiment, the sheath may be elongated based on the phase changing of the phase change material. According to an embodiment of the disclosure, the sheath may be elongated based on the expansion of the core. Since the sheath surrounds at least a portion of the core, it is elongated according to the expansion of the core, thereby reducing movement of the polymer material in the core to the outside of the fiber.

According to an embodiment, a melting point of the polymer material may be higher than a melting point of the phase change material. According to an embodiment of the disclosure, since the melting point of the polymer material in the sheath is higher than the melting point of the phase change material in the core, even when the phase change material is melted, it may maintain a solid phase state. By maintaining the solid phase state of the polymer material, the polymer material may maintain the core-sheath structure.

According to an embodiment, the phase change material may include at least one of a paraffin, polyethylene glycol, sodium acetate trihydrate, sodium hydroxide monohydrate, magnesium nitrate hexahydrate, myristic acid, stearic acid, and xylitol. According to an embodiment of the disclosure, the phase change material may include a material having a relatively high latent heat and capable of repeatedly performing a melting and solidification process. Since the high latent heat of the phase change material may absorb and store a relatively large amount of heat energy, the separator may suppress the temperature increase of the battery.

According to an embodiment, the polymer material may include at least one of polyvinylidene fluoride (PVDF), polydimethylsiloxane (PDMS), polyethylene (PE), polyvinyl alcohol (PVA), and polyvinyl pyrrolidone (PVP).

According to an embodiment, the polymer material may include metallic oxide. According to an embodiment of the disclosure, the polymer material in the sheath may include a material that provides stability of the separator by providing mechanical strength of the separator.

According to an embodiment, a melting point of the phase change material may be 28° C. to 90° C. According to an embodiment of the disclosure, the phase change material may be melted at a temperature higher than the melting point. When the phase change material is melted, the temperature increase of the battery may be reduced by absorbing heat energy.

According to an embodiment, a porosity of the separator may be 30 to 80%. According to an embodiment of the disclosure, the separator may include pores for enabling passage of ions. Since ions (e.g., lithium cations) may move through the pores, charging and/or discharging of the battery may be possible.

According to an embodiment, a width (e.g., the width w2 of FIG. 5A) of the core may be greater than or equal to 50% of a width (e.g., the width w1 of FIG. 5A) of the fiber.

According to an embodiment, a width of the fiber may be from 1 nm to 1,000 nm. According to an embodiment of the disclosure, the width of the fiber may vary according to the type, size, and use of the battery.

According to an embodiment, the core may include 10 weight percent (wt %) to 90 wt % of the phase change material.

According to an embodiment, the battery may further include a case (e.g., the case 340 of FIG. 3A) for accommodating the first electrode, the second electrode, and the separator. The sheath may be in contact with an electrolyte (e.g., the electrolyte 350 of FIG. 3A) in the case. According to an embodiment of the disclosure, the separator may include a phase change material in the core without including a coating layer formed of a phase change material. The separator including a fiber of a core-sheath structure may be relatively thin because it does not include a separate coating layer. According to an embodiment, the battery may have a relatively high energy density.

According to an embodiment, the phase change material may be configured to reduce, when an external object (e.g., the external object O of FIG. 7) penetrates the separator, a temperature increase of the battery by surrounding the external object. According to an embodiment of the disclosure, the phase change material may surround, when the external object penetrates the battery, the external object at a penetration portion. When the external object penetrates the battery, a short circuit may be formed inside the battery. Due to the short circuit, the temperature of the battery may increase, and the phase change material may be changed from solid phase to liquid phase by absorbing heat energy. The phase change material in the liquid phase may block a flow of a short circuit current formed through the external object by surrounding the external object. According to an embodiment, in a state that the external object penetrates the battery, the separator may suppress the temperature increase of the battery and reduce ignition.

An electronic device (e.g., the electronic device 101 of FIG. 2B) according to an embodiment may include a battery (e.g., the battery 189 of FIG. 3A) and PMIC (e.g., the PMIC 360 of FIG. 2B). The battery may be configured to provide power to at least one component of the electronic device. The PMIC may be configured to manage power provided from the battery to the at least one component. The battery may include a first electrode, a second electrode, and a separator. The second electrode may be spaced apart from the first electrode. The separator may be disposed between the first electrode and the second electrode. The separator may include a fiber. The fiber may include a core and a sheath. The sheath may at least partially surround the core. The core may include a phase change material. The sheath may include a polymer material. According to an embodiment of the disclosure, the separator may be configured to reduce a temperature increase of the battery. For example, when the temperature of the battery increases due to an internal short circuit, the phase change material in the core may be changed from solid phase to liquid phase by absorbing heat energy. As the temperature increase of the battery is reduced by the phase change material, overheating and/or ignition of the battery may be reduced. Since the battery according to an embodiment does not easily overheat, it may provide stability during use and efficiently provide power. According to an embodiment, since the separator may include a phase change material through a core-sheath structure without including a separate coating layer, a thickness of the separator may be relatively thin. Since the thickness of the separator is thin, the battery may have a relatively high energy density.

According to an embodiment, the phase change material may include at least one of a paraffin, polyethylene glycol, sodium acetate trihydrate, sodium hydroxide monohydrate, magnesium nitrate hexahydrate, myristic acid, stearic acid, and xylitol. According to an embodiment of the disclosure, the phase change material may include a material having a relatively high latent heat and capable of repeatedly performing a melting and solidification process. Since the high latent heat of the phase change material may absorb and store a relatively large amount of heat energy, the separator may suppress the temperature increase of the battery.

According to an embodiment, the polymer material may include at least one of polyvinylidene fluoride (PVDF), polydimethylsiloxane (PDMS), polyethylene (PE), polyvinyl alcohol (PVA), and polyvinyl pyrrolidone (PVP).

According to an embodiment, the polymer material may include metallic oxide. According to an embodiment of the disclosure, the polymer material in the sheath may include a material capable of providing stability of the separator by providing mechanical strength of the separator.

According to an embodiment, a melting point of the phase change material may be 28° C. to 90° C. According to an embodiment of the disclosure, the phase change material may be melted at a temperature higher than the melting point. When the phase change material is melted, the temperature increase of the battery may be reduced by absorbing heat energy.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A battery comprising:
a first electrode;
a second electrode spaced apart from the first electrode; and
a separator including a fiber disposed between the first electrode and the second electrode, the fiber including a core and a sheath at least partially surrounding the core,
wherein the core of the fiber includes a phase change material, and
wherein the sheath of the fiber includes a polymer material.

2. The battery of claim 1, wherein, when a temperature of the battery increases, the phase change material is configured to reduce a temperature increase of the battery by a phase changing from solid phase to liquid phase.

3. The battery of claim 1,
wherein, when a temperature of the battery increases, the separator is configured to expand as the phase change material in the core changes from solid phase to liquid phase, and
wherein a contraction of the separator is compensated through the expansion of the separator.

4. The battery of claim 1, wherein the sheath of the fiber is configured to elongate based on a phase changing of the phase change material.

5. The battery of claim 1, wherein a melting point of the polymer material is higher than a melting point of the phase change material.

6. The battery of claim 1, wherein the phase change material includes at least one of a paraffin, polyethylene glycol, sodium acetate trihydrate, sodium hydroxide monohydrate, magnesium nitrate hexahydrate, myristic acid, stearic acid, or xylitol.

7. The battery of claim 1, wherein the polymer material includes at least one of polyvinylidene fluoride (PVDF), polydimethylsiloxane (PDMS), polyethylene (PE), polyvinyl alcohol (PVA), and polyvinyl pyrrolidone (PVP).

8. The battery of claim 1, wherein the polymer material includes a metallic oxide.

9. The battery of claim 1, wherein a melting point of the phase change material is from 28° C. to 90° C.

10. The battery of claim 1, wherein a porosity of the separator is from 30% to 80%.

11. The battery of claim 1, wherein a width of the core is 50% or more of a width of the fiber.

12. The battery of claim 1, wherein a width of the fiber is from 1 nanometer (nm) to 1,000 nm.

13. The battery of claim 1, wherein the phase change material is from 10 weight percent (wt %) to 90 wt % of the core of the fiber.

14. The battery of claim 1, further comprising:
a case configured to accommodate the first electrode, the second electrode, and the separator,
wherein the sheath of the fiber contacts an electrolyte in the case.

15. The battery of claim 1, wherein, when an external object penetrates the separator, the phase change material is configured to reduce a temperature increase of the battery by surrounding the external object.

16. An electronic device comprising:
a battery configured to provide power to at least one component of the electronic device; and
power management integrated circuitry configured to manage the power provided from the battery to the at least one component,
wherein the battery comprises:
a first electrode,
a second electrode spaced apart from the first electrode, and
a separator including a fiber disposed between the first electrode and the second electrode, the fiber including a core and a sheath at least partially surrounding the core,
wherein the core of the fiber includes a phase change material, and
wherein the sheath of the fiber includes a polymer material.

17. The electronic device of claim 16, wherein the phase change material includes at least one of a paraffin, polyethylene glycol, sodium acetate trihydrate, sodium hydroxide monohydrate, magnesium nitrate hexahydrate, myristic acid, stearic acid, or xylitol.

18. The electronic device of claim 16, wherein the polymer material includes at least one of polyvinylidene fluoride (PVDF), polydimethylsiloxane (PDMS), polyethylene (PE), polyvinyl alcohol (PVA), or polyvinyl pyrrolidone (PVP).

19. The electronic device of claim 16, wherein the polymer material includes a metallic oxide.

20. The electronic device of claim 16, wherein a melting point of the phase change material is from 28° C. to 90° C.
